(19) United States
(12) Patent Application Publication
(10) Pub. No.: US 2015/0013073 A1
(43) Pub. Date: Jan. 15, 2015

(54) THERAPY CONTROL FOR PATIENT SUPPORT SYSTEM

(71) Applicant: AMERICAN HOME HEALTH CARE, INC., Westerville, OH (US)

(72) Inventors: Jay Schwirian, Monongahela, PA (US); Bradley Yakam, New Albany, OH (US)

(73) Assignee: AMERICAN HOME HEALTH CARE, INC., Westerville, OH (US)

(21) Appl. No.: 14/499,371

(22) Filed: Sep. 29, 2014

Related U.S. Application Data
(63) Continuation-in-part of application No. 13/158,725, filed on Jun. 13, 2011.
(60) Provisional application No. 61/883,638, filed on Sep. 27, 2013.
(60) Provisional application No. 61/354,214, filed on Jun. 12, 2010.

(51) Int. Cl. A61G 7/057; G01G 19/44; A47C 27/08

(52) U.S. Cl. CPC A61G 7/05776; A47C 27/082; A47C 27/083; A61G 7/05769; G01G 19/445; A61G 2203/34; A61G 2203/46; A61G 2203/44
USPC 5/706; 5/655.3; 5/654

(57) ABSTRACT

Patient support systems and, more particularly, patient support systems designed to reduce the risk of developing pressure sores by a patient are disclosed. A control unit is provided that operates a pump for setting and maintaining the inflation of the patient support system. The control unit is configured to receive a weight of a patient (either automatically from an integrated weighing device or as input by a caregiver) using the patient support system. The control unit then operates the pump to fill and maintain the patient support system to a predetermined pressure based upon an electronically stored pressure versus weight model accessible to the control unit, where the pressure versus weight model is set to avoid bottom-out and overpressure conditions for the patient having the weight.

### CROSS REFERENCE TO RELATED APPLICATIONS

The present application is a continuation-in-part application from U.S. application Ser. No. 13/158,725, filed Jun. 13, 2011, and also claims priority to U.S. Provisional Application Ser. No. 61/883,638, filed Sep. 27, 2013; the disclosure of which is incorporated herein by reference.

### TECHNICAL FIELD

The present disclosure generally pertains to patient support systems and, more particularly, to patient support systems (sometimes referred to as “support surface” systems) designed to reduce the risk of developing pressure sores by a patient.

### BACKGROUND

It is known in the field of patient support systems that pressure sores in patients, particularly long term care patients, can be problematic. In the past, there have been support systems designed to help alleviate such pressure sores. For example, U.S. Pat. No. 3,822,425 discloses an air mattress consisting of a number of cells or bags, each having a surface which supports a patient, wherein the support system is formed from a material which is gas permeable but is non-permeable to liquids and solids. It also discloses an air supply for inflating the cells to the required pressure and outlets or exhaust ports to allow the escape of air. The stated purpose of the outlets is to remove condensed vapor for the cells or bags. The outlets on that support system may be fitted with valves to regulate the air pressure in the cells as opposed to regulating the air pressure in the cells by controlling the amount of air flowing into the cells.

Other examples of prior art patient support systems are disclosed in, for example, U.S. Pat. Nos. 3,477,071, 3,485,240, and 3,775,781. These patents disclose patient support systems that are designed to rock a patient back and forth by the use of air pressure. Specifically, the prior art patient support structure systems disclosed in these U.S. patents include support structures with an inflatable device for shifting or turning a patient lying on the support structure by alternately inflating and deflating one or more inflatable cushions. In another related disclosure, U.S. Pat. No. 3,678,520 discloses an air cell for use in a pressure pad which is provided with a plurality of tubes which project from a header pipe such that the air cell assumes a comb-like conformation when inflated and viewed from above.

A number of prior art disclosures disclose patient support systems or cushions comprised of sets of cells which are alternately inflated and deflated to support a patient first on one group of air cells and then the other group. Those patents include U.S. Pat. Nos. 4,068,334, 4,175,297, 4,193,149, 4,197,837, 4,225,989, 4,347,633, 4,391,009, and 4,472,847.

However, none of these prior art disclosures appears to have resolved all deficiencies and/or issues involved in pressure sores in patients. Specifically, it has been found that patient support systems that include inflatable sections must be adjusted on a patient-by-patient basis depending on the individual characteristics of each patient, most notably weight, to insure that when the patient is lying on the patient support system no part of the patient “bottoms out” (i.e. presses against a lower un-inflated area of the support system). In the past, this has been done manually by a caregiver individually inflating the zones in the patient support system separately with the patient lying on the support structure, while hand-checking the support system to insure that there are no pressure points created by the patient “bottoming out” on an underinflated portion of the support system. Accordingly, a patient support structure which allows inflatable patient support system to be automatically adjusted to a particular patient characteristic which does not require individual caregiver hand-checking for each patient is desired.

### SUMMARY

Patient support systems are generally disclosed. Some example embodiments may include methods, apparatus, and/or systems pertaining to patient support systems designed to reduce the risk of developing pressure sores. Patient support systems in accordance with the disclosure may include mattresses for support structures, or may comprise pressure pads for use in seating applications, such as, for example, wheelchairs. Other patient support systems within the scope of the disclosure include gurney pads and OR pads. Other forms of patient support systems including inflatable elements are considered within the realm of the disclosure.

Specifically, patient support systems in accordance with the disclosure are comprised of systems, methods and apparatuses wherein inflation of zones of an inflatable patient support system is accomplished by inputting the weight of the patient whom is using the support system and automatically inflating the patient support system to a proper inflation level (or zones thereof, if applicable) to insure no “bottoming out” of the patient on the support system. In accordance therewith, patient support systems, methods and apparatuses in accordance with the disclosure do not require a caregiver to individually hand-check the support system to insure that the patient is not bottoming-out on an underinflated portion of the patient support system.

Example patient support systems which may be used in accordance with the present disclosure include any patient support systems that are inflatable. Such patient support systems may or may not include multiple zones. One non-limiting example of a patient support system for use in accordance with the present disclosure includes the patient support system disclosed in co-pending U.S. Pub. No. 2011/0302718 A1 owned by the assignee of the present disclosure, the contents of which are herein incorporated by reference in their entirety.

In accordance therewith, a patient support system which may be used in accordance with the present disclosure may include a generally rectangular base comprising a top surface. A first longitudinally oriented sidewall and a second longitudinally oriented sidewall may extend upward from lateral side portions of the base. A substantially vapor-impermeable barrier may be disposed on the top surface of the base and on inwardly facing surfaces of the first longitudinally oriented sidewall and the second longitudinally oriented sidewall. A substantially vapor-permeable top cover may extend between upper aspects of the first longitudinally oriented sidewall and the second longitudinally oriented sidewall such that a generally longitudinally oriented channel configured to receive airflow therethrough may be substantially defined by a lower surface of the top cover, an upper surface of the barrier on the base, and inwardly facing surfaces of the barrier on the first longitudinally oriented sidewall and the second longitudinally oriented sidewall. A supply conduit may extend from an exterior air supply connector to an internal air supply opening within the channel. An air discharge opening within the channel may be arranged to allow air to exit the channel. An inflatable support may be disposed in the channel. An interior volume of the inflatable support may be fluidicly isolated from the channel, such that the air supply connector may be removed, if desired, once the support system has achieved a desired inflation level (known as a “closed” system). Conversely, in accordance with the disclosure, the system may utilize an exterior air supply system that is maintained in fluidic communication with the support system (known as an “open” system).

Further, some example support structure systems according to at least some aspects of the present disclosure may include a support structure configured to receive a patient. The support structure may include a first inflatable support and a second inflatable support disposed within the support structure. The first inflatable support and the second inflatable support may be independently inflatable. Each of the first inflatable support and the second inflatable support may support at least a portion of the patient's weight when the patient is in a generally supine position on the support structure. The first inflatable support and the second inflatable support may have respective unloaded pressures. The first inflatable support and the second inflatable support may have respective loaded pressures when the patient is in the generally supine position on the support structure. The respective loaded pressures may be greater than the respective unloaded pressures.

Some example patient weighing systems according to at least some aspects of the present disclosure may include an inflatable mat configured to be disposed on a support structure frame and beneath a support structure. The inflatable mat may include an upper, substantially air-impermeable layer; a lower, substantially air-impermeable layer; and a middle volume interposing the upper layer and the lower layer. The middle volume may include a plurality of threads connecting the upper layer and the lower layer at a substantially fixed distance. The upper layer and the lower layer may form a substantially air-tight volume housing the middle volume. The patient weighing system may include a pressure sensor arranged to sense an inflation pressure of the inflatable mat and a user interface unit operatively connected to the pressure sensor. The interface unit may be programmed to detect a difference between an unloaded pressure of the mat and a loaded pressure of the mat and to output a patient weight corresponding to the difference.

Some example methods of determining a patient weight according to at least some aspects of the present disclosure may include receiving a patient on a support structure. The support structure may be supported by an inflatable mat. The inflatable mat may include an upper, substantially air-impermeable layer, a lower, substantially air-impermeable layer, and a middle volume interposing the upper layer and the lower layer. The middle volume may include a plurality of threads connecting the upper layer and the lower layer at a substantially fixed distance. The method may include sensing a loaded pressure of the inflatable mat and outputting a patient weight corresponding to a difference between the loaded pressure of the inflatable mat and an unloaded pressure of the inflatable mat. Other methods of determining a patient weight in accordance with at least some aspects of the embodiment include a caregiver weighing the patient prior to being placed on the support structure or by receiving the patient weight from another source, i.e. a corresponding patient chart and/or the bed-frame (in frames which include a patient weighing function). In accordance with some aspects of these embodiments, the patient weight may be transmitted to a user interface and/or control unit either manually, or electronically (including through a wired Internet connection, WiFi Internet connection, Bluetooth, etc.).

Some example patient support systems according to at least some aspects of the present disclosure may include a support structure configured to receive a patient. The support structure may include a first inflatable support and a second inflatable support. The first inflatable support and the second inflatable support may be independently inflatable. Each of the first inflatable support and the second inflatable support may support at least a portion of the patient's weight when the patient is in a generally supine position on the support structure. The first inflatable support and the second inflatable support may have respective unloaded pressures. The first inflatable support and the second inflatable support may have respective loaded pressures when the patient is in the generally supine position on the support structure. The respective loaded pressures being greater than the respective unloaded pressures. A patient support system may include an inflatable mat disposed between the first and second inflatable supports and a support structure frame. The inflatable mat may include an upper, substantially air-impermeable layer, a lower, substantially air-impermeable layer, and a middle volume interposing the upper layer and the lower layer. The middle volume may include a plurality of threads connecting the upper layer and the lower layer at a substantially fixed distance. The upper layer and the lower layer may form a substantially air-tight volume housing the middle volume. A patient support system may include a first pressure detector associated with the first inflatable support, a second pressure detector associated with the second inflatable support, an inflatable mat pressure sensor arranged to sense an inflation pressure of the inflatable mat, and a user interface unit. A user interface and/or control unit may include a patient weight display configured to indicate a patient weight calculated by a patient weight logic. The patient weight logic may be operatively connected to the inflatable mat pressure sensor. The patient weight logic may be programmed to detect a difference between an unloaded pressure of the inflatable mat and a loaded pressure of the inflatable mat and to output the patient weight based at least partially on the difference.

Some example patient support systems according to at least some aspects of the present disclosure may comprise a control unit that operates a pump for setting and maintaining the inflation of the patient support system. In accordance therewith, the control unit may be configured to receive a weight of a patient (either automatically from an integrated weighing device, such as those disclosed herein, or as input by a caregiver, or otherwise received as discussed above) using the patient support system. The control unit may then operate the pump to perform various activities including a self-check, a leak check, as well as filling the support structure to a predetermined pressure based upon the weight of the patient. In accordance with a closed system embodiment, the support structure may be disconnected from the pump after the predetermined pressure is achieved. In accordance with an open system embodiment, the pump may remain fluidicly connected to the support structure. Further, in such an open system, the control unit may periodically check the pressures received from the support structure to ensure that actual pressure is within a predetermined range of a predetermined desired pressure target. In accordance with embodiments of the disclosure wherein the patient support system includes multiple independently inflatable zones, the control unit may operate the pump to independently inflate and maintain each of the zones according to a predetermined pressure profile corresponding with the weight of the patient.

In accordance with patient support systems disclosed herein, the control unit may receive a pneumatic input from a pump and include separate pneumatic outputs that are fluidicly connected to the inflatable sections of the patient support system. In embodiments of the disclosure wherein the patient support system includes multiple zones, the control unit may include multiple pneumatic outputs corresponding to each of the zones.

In accordance with aspects of the invention, the control unit (or other portion of the system) may provide audible feedback (beeps, etc) to indicate various stages of the filling process of the inflatable portions of the patient support systems, including a specific audible feedback for when the support system has been inflated to the appropriate pre-determined pressure. Additionally, the control unit may provide audible and/or visual feedback as to other read conditions, i.e. pressure readings below or above desired predetermined pressure targets.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a block diagram of an example patient support system in accordance with one aspect of the present disclosure;

FIG. 2 is an exploded perspective view of an example support structure system in accordance with one aspect of the present disclosure;

FIG. 3 is a plan view of an example support structure with the top cover removed system in accordance with one aspect of the present disclosure;

FIG. 4A is an exploded cross-sectional view of an example support structure system in accordance with one aspect of the present disclosure;

FIG. 4B is a cross-sectional view of an example support structure system in accordance with one aspect of the present disclosure;

FIG. 5 is a cross-sectional view of an example support structure illustrating an alternative arrangement of the side walls system in accordance with one aspect of the present disclosure;

FIG. 6 is a cross-sectional view of an example support structure illustrating the side walls integrally formed with the base system in accordance with one aspect of the present disclosure;

FIG. 7 is a perspective view of an example base, side walls, and head end wall system in accordance with one aspect of the present disclosure;

FIG. 8 is a detailed perspective view of a head end of an example support structure system in accordance with one aspect of the present disclosure;

FIG. 9 is a cross-sectional view of an example inflatable mat system in accordance with one aspect of the present disclosure;

FIG. 10 is a block diagram of an example control unit system in accordance with one aspect of the present disclosure;

FIG. 11 is a block diagram of an example inflation system in accordance with one aspect of the present disclosure;

FIG. 12 is a block diagram of another example of a patient support system in accordance with one aspect of the present disclosure;

FIG. 13 is a block diagram of another example of a patient support system in accordance with one aspect of the present disclosure;

FIG. 14 is a block diagram of an example handheld control unit system in accordance with one aspect of the present disclosure;

FIG. 15 is a perspective view of a control unit for use in connection with a patient support system in accordance with an aspect of the present disclosure;

FIG. 16 is a flowchart of an example method of operating a patient support system in accordance with one aspect of the present disclosure;

FIG. 17 is a flowchart of an example method of operating a patient support system in accordance with one aspect of the present disclosure; and

FIG. 18 is a block diagram of an example computer; all arranged system in accordance with one aspect of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

Methods, systems, devices, and/or apparatus related to patient support systems are described. Some example embodiments according to the present disclosure may pertain to patient support systems designed to reduce the risk of developing pressure sores and/or to provide patient weighing. Some example embodiments according to the present disclosure may include patient support systems operable as patient beds/mattresses, wheelchair pads, gurney pads, OR pads, etc.

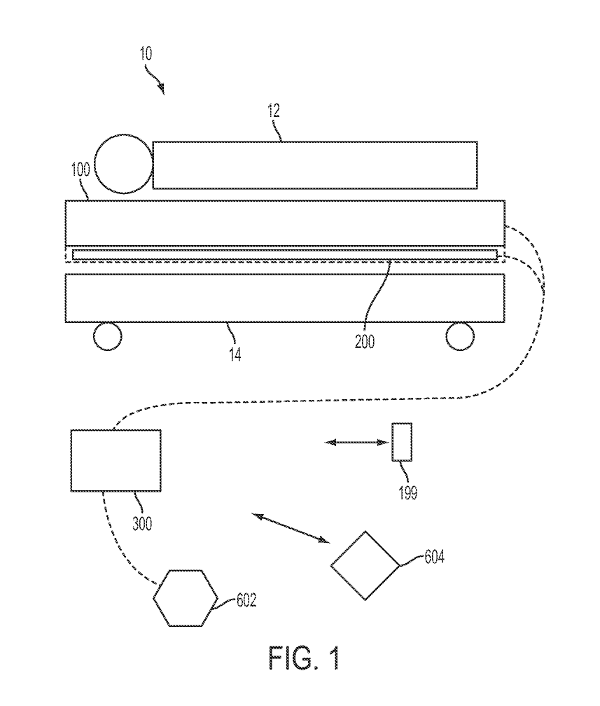

FIG. 1 is a block diagram of an example patient support system 10, according to at least some embodiments of the present disclosure. A patient may lie on a support structure 100 (which may be referred to as a mattress), which may be disposed on a support structure frame 14, such as a hospital support structure frame. In some example embodiments, a mat 200 may interpose mattress 100 and support structure frame 14. In some example embodiments, support structure 100 and/or mat 200 may be operatively connectable to a control unit 300.

Control unit 300, support structure 100, and/or sensor mat 200 may be configured to perform functions such as, for example and without limitation, supplying air to and/or venting air from one or more inflatable portions of support structure 100, flowing air through one or more portions of support structure 100, and/or sensing, displaying, and/or recording various parameters and/or events associated with support structure 100 and/or mat 200. In some example embodiments, control unit 300 may be operatively connectable to an external power source 602 and/or an external communication device 604 (e.g., via a wired and/or wireless connection). In some example embodiments, a remote control 199 may be operatively connected to control unit 300, such as by a wired and/or wireless connection.

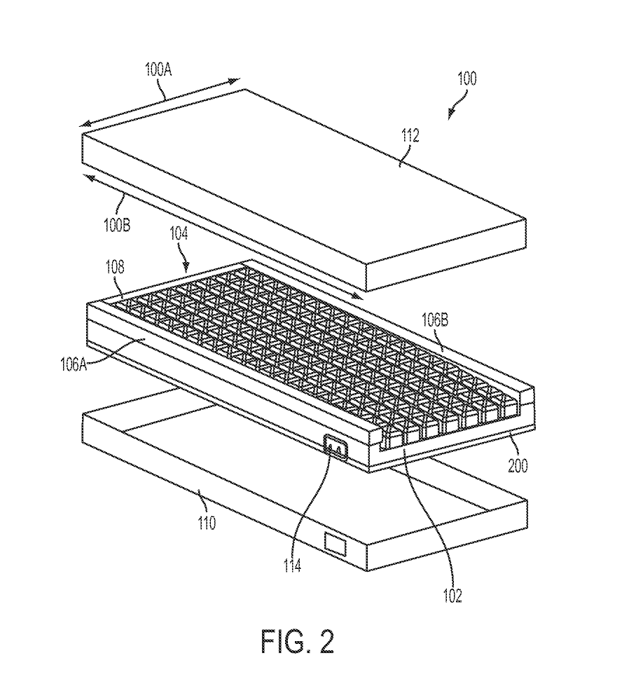

FIG. 2 is an exploded perspective view of an example support structure 100, according to at least some embodiments of the present disclosure. Support structure 100 may include a base 102, one or more inflatable supports 104 (which may be disposed substantially within support structure 100), one or more longitudinally oriented side walls 106A, 106B extending upward from lateral side portions of base 102, one or more end walls (e.g., a head end wall 108, which may extend upward from a head end portion of base and/or may extend laterally from side wall 106A to side wall 106B), a bottom cover 110, and/or a top cover 112. Base 102 may be generally rectangular and/or may extend for substantially the entire width 100A of mattress 100 and/or substantially the entire length 100B of mattress 100.

In some example embodiments, mat 200 may be disposed within bottom cover 110 beneath base 102, and in some example embodiments mat 200 may be disposed beneath bottom cover 110 (e.g., between bottom cover 110 and support structure frame 14 (FIG. 1)). Inflatable support 104 may have a width less than width 100A of support structure 100 and/or a length less than length 100B of mattress 100. Some example embodiments may not include both side walls 106A, 106B and/or head end wall 108, and some example embodiments may additionally include a foot end wall generally similar to head end wall 108. Some example embodiments may include an external connection panel 114, which may include one or more connectors coupled to internal components of support structure 100 as described below.

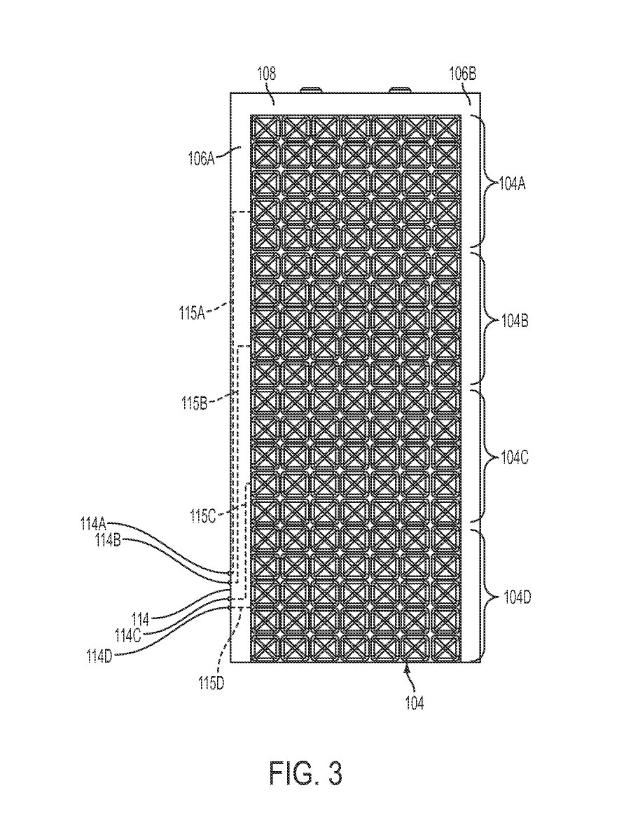

FIG. 3 is a plan view of an example support structure 100 with top cover 112 removed, according to at least some embodiments of the present disclosure. In some example embodiments, inflatable support 104 may include one or more sections, each of which may comprise a plurality of fluidicly connected, upstanding chambers. For example, in some example embodiments, inflatable support 104 may include inflatable support sections 104A, 104B, 104C, 104D arranged from head to foot (e.g., a head section, a torso section, a hip section, and a foot section).

Individual support sections 104A, 104B, 104C, 104D may comprise about 35 fluidicly connected, upstanding chambers. For example, individual support sections 104A, 104B, 104C, 104D may be generally similar to those manufactured by ROHO Group, Inc. of Belleville, Ill. In some example embodiments, individual chambers may be about 3″ wide by about 3″ long by about 2½″ high and/or may be constructed at least partially from urethane. In some example embodiments, individual chambers may be about 1″ wide by about 1″ long by about 3″ high and/or may be constructed at least partially from neoprene.

In some example embodiments, inflatable support sections 104A, 104B, 104C, 104D may be individually inflated or deflated as desired. For example, inflatable support sections 104A, 104B, 104C, 104D may be inflated to respective unloaded pressures prior to the patient being received on support structure 100. Respective loaded pressures (e.g., when a patient is lying on support structure 100) of inflatable support sections 104A, 104B, 104C, 104D may be greater than the respective unloaded pressures.

In some example embodiments, external connection panel 114 may comprise one or more connectors 114A, 114B, 114C, 114D, which may be fluidicly connected to inflatable support sections 104A, 104B, 104C, 104D via channels 115A, 115B, 115C, 115D (such as may be provided by tubing or a manifold), respectively. One or more of connectors 114A, 114B, 114C, 114D may comprise quick-disconnect fittings, which may be internally valved to prevent leakage of air from inflatable support sections 104A, 104B, 104C, 104D when disconnected. Connectors 114A, 114B, 114C, 114D may be operatively coupled to control unit 300, which, for example, may sense respective pressures of inflatable support sections 104A, 104B, 104C, 104D and/or may provide air to or vent air from of inflatable support sections 104A, 104B, 104C, 104D.

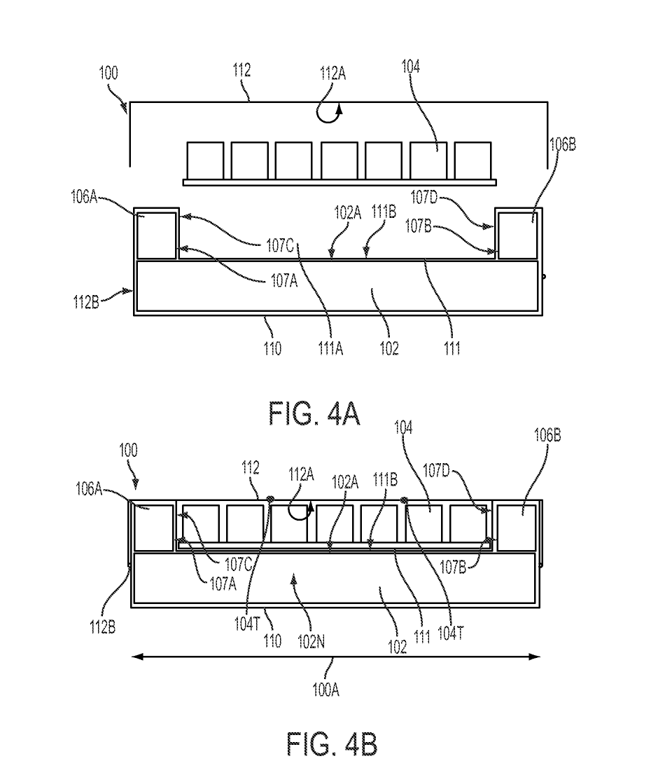

FIGS. 4A and 4B are an exploded cross-sectional view of an example support structure 100 and a cross-sectional view of an example support structure 100, respectively, according to at least some embodiments of the present disclosure. Base 102 may include a top surface 102A, which may be substantially planar. Inflatable support 104, side walls 106A, 106B, and/or head end wall 108 (see FIG. 2) may be positioned on top surface 102A of base 102 and/or may be at least partially enclosed by fabric or other covering, which may comprise portions of bottom cover 110. In an assembled support structure 100, inflatable support 104 may lie within a cavity at least partially defined below by top surface 102A of base 102, on the lateral sides by inwardly facing surfaces 107A, 107B of side walls 106A, 106B, and/or on the head end by head end wall 108.

In some example embodiments, a substantially vapor-impermeable barrier 111 may be disposed on at least a portion of top surface 102A of base 102 and/or on inwardly facing surfaces 107A, 107B of side walls 106A, 106B. In some example embodiments, barrier 111 may comprise a portion of bottom cover 110. In some example embodiments, top cover 112 may be releasably joined to bottom cover 110 by a fastener, such as zipper 112A.

In some example embodiments, an upper surface 111B of barrier 111 on base 102, inwardly facing surfaces 107C, 107D of barrier 111 on side walls 106A, 106B, and/or at least a portion of a lower surface 112A of top cover 112 may substantially define a generally longitudinally oriented channel 111A. Inflatable support 104 may be disposed within channel 111A and/or an interior volume of inflatable support 104 may be fluidicly isolated from channel 111A.

In some example embodiments, support structure 100 may include one or more sensors, which may be operatively coupled control unit 300. Example sensors may include one or more temperature sensors 104T (e.g., an infrared temperature sensor), one or more humidity sensors 104H, and/or one or more angle sensors 102N (e.g., a potentiometer). Temperature sensor 104T and/or humidity sensor 104H may be configured to detect conditions approximate top cover 112, which may be indicative of conditions at an interface between a patient and support structure 100. Angle sensor 102N may be configured to detect the angle of elevation of the head portion of support structure 100 and/or may be mounted within and/or on base 102.

In some example embodiments, base 102, side walls 106A, 106B, and/or head end wall 108 may be constructed from foam (e.g., polyurethane foam) and/or non-foam materials. Example non-foam materials include, but are not limited to, fibrous materials (e.g., non-woven, randomly oriented polyester fiber materials, such as Indura Performance Fiber, available from Indratech of Auburn Hills, Mich.), gels, viscous fluids such as silicone, and/or other natural or manmade materials conventionally utilized in mattresses and/or tubes. In some example embodiments, base 102, side walls 106A, 106B, and/or head end wall 108 may comprise one or more air bladders. For example, in some example embodiments, base 102 may be constructed from foam and/or side walls 106A, 106B may be constructed from a non-foam material. In other example embodiments, base 102 may comprise one or more air bladders, without foam. In other example embodiments, side walls 106A, 106B may comprise one or more air bladders.

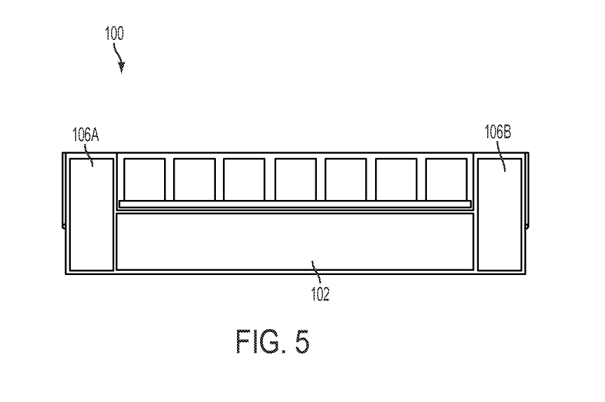

FIG. 5 is a cross-sectional view of an example support structure illustrating an alternative arrangement of side walls 106A, 106B, according to at least some embodiments of the present disclosure. In some example embodiments, side walls 106A, 106B may be disposed against outwardly facing lateral side edges of base 102.

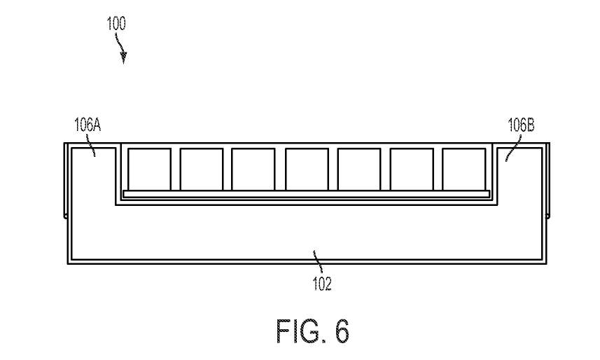

FIG. 6 is a cross-sectional view of an example support structure illustrating side walls 106A, 106B integrally formed with base 102, according to at least some embodiments of the present disclosure. In some example embodiments, side walls 106A, 106B may be integrally formed with base 102.

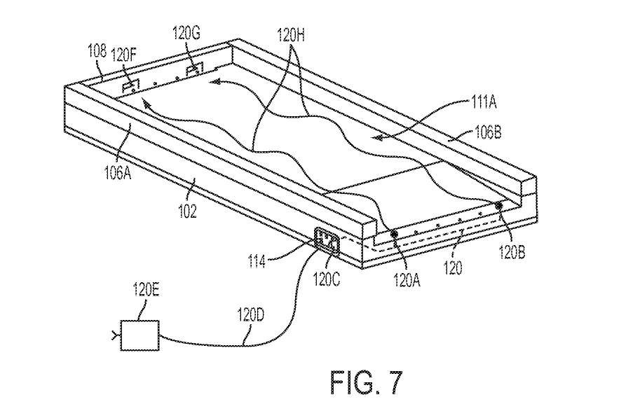

FIG. 7 is a perspective view of an example base 102, side walls 106A, 106B, and head end wall 108, according to at least some embodiments of the present disclosure. Some example embodiments may be configured to provide forced air flow through support structure 100, which may be referred to as “low air loss.” For example, as illustrated in FIG. 7, some embodiments may include an air supply conduit 120 extending from an exterior air supply connector 120C (which may be disposed on external connection panel 114) to one or more internal air supply openings 120A, 120B.

In some example embodiments, internal air supply openings 120A, 120B may be disposed within channel 111A approximate a foot end of base 102. Air may be supplied to exterior air supply connector 120C from an air source 120E (e.g., a blower) via an air supply conduit 120D. In some example embodiments, air source 120E may be provided as part of or in connection with to control unit 300 (FIG. 1).

Some example embodiments may include one or more air discharge openings 120F, 120G, which may be arranged to allow air to exit channel 111A, such as to an ambient environment. Air discharge openings 120F, 120G may extend through head end wall 108, for example, and may be disposed within channel 111A approximate the head end of base 102. Delivering air to channel 111A via internal air supply openings 120A, 120B and venting air through air discharge openings 120F, 120G may cause air flow along generally foot-to-head flowpaths 120H.

Some example embodiments may be configured so that air flow through support structure 100 (e.g., low air loss air flow) may be substantially independent of the air within the interiors of inflatable support sections 104A, 104B, 104C, 104D. Accordingly, a patient receiving low air loss therapy may remain supported by inflatable support sections 104A, 104B, 104C, 104D, even if air source 120E is turned off, unplugged, etc. Similarly, support structure 100 may be used without low air loss therapy, if desired. In some example embodiments, the independence of the inflation of inflatable support sections 104A, 104B, 104C, 104D and the low air loss air flow may allow use of a smaller, quieter, and more energy efficient air source 120E than may be required for conventional low air loss systems in which the air source may provide both supporting inflation and air flow.

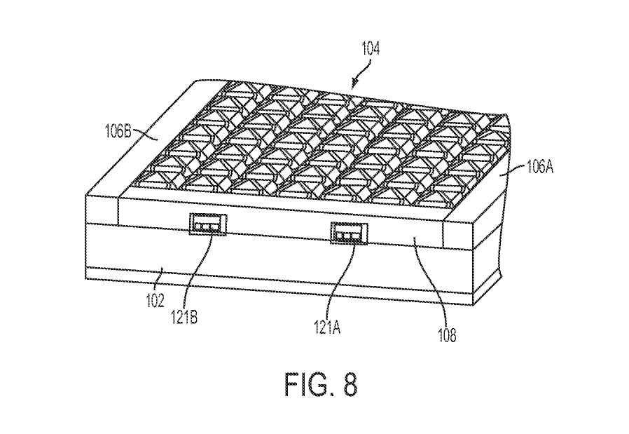

FIG. 8 is a detailed perspective view of a head end of an example support structure 100, according to at least some embodiments of the present disclosure. Some example embodiments may include grates 121A, 121B, which may provide vent paths from air discharge openings 120F, 120G (FIG. 7) through head end wall 108 and/or top cover (FIG. 2). Grates 121A, 121B may house one or more filters, which may comprise mesh screens. Example mesh screens may include a sintered stainless steel mesh (e.g., about 44 micron).

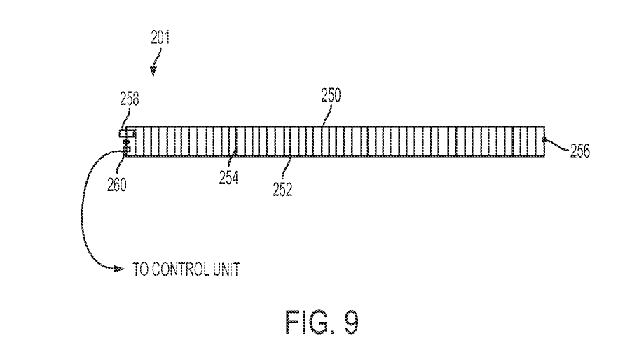

FIG. 9 is a cross-section view of an example inflatable mat 201, according to at least some embodiments of the present disclosure. Inflatable mat 201 may comprise mat 200, described above. Inflatable mat 201 may be configured to be disposed on support structure frame 14 (FIG. 1) and beneath support structure 100, such as within the outer covering (e.g., bottom cover 110) of support structure 100 and beneath the patient support components (e.g., base 102 and inflatable supports 104). Alternatively, inflatable mat 201 may be disposed between the outer covering (e.g., bottom cover 110) of support structure 100 and support structure frame 14. Some example inflatable mats 201 may be sized to underlie substantially the entire base 102 and/or the entire support structure 100.

Some example inflatable mats 201 may comprise a drop-stitch fabric, which may comprise an upper, substantially air-impermeable layer 250; a lower, substantially air-impermeable layer 252; and/or a middle volume 254, which may interpose upper layer 250 and lower layer 252. Middle volume 254 may comprise a plurality of threads connecting upper layer 250 and lower layer 252 at a substantially fixed distance. Upper layer 250 and lower layer 252 may be sealed together (e.g., at seal 256) to provide a substantially air-tight volume housing middle volume 254. Some example embodiments may include an inflation port 258 and/or a pressure sensor 260, which may be configured to sense an inflation pressure of inflatable mat 201 and/or may be operatively coupled to control unit 300. In some example embodiments, inflatable mat 201 may be about 1 inch thick.

In some example embodiments, inflatable mat 201 may be inflated to an unloaded pressure prior to the patient being received on support structure 100. A loaded pressure (when the patient is lying on support structure 100) of inflatable mat 201 may be greater than the unloaded pressure.

Example control units 300 according to at least some aspects of the present disclosure may comprise various systems and/or may be configured to perform various functions, depending on the desired characteristics of the particular embodiments. Accordingly, the following description pertains to various optional systems, components, and/or functions, and example control units 300 may comprise any number of these and other systems, components, and/or functions.

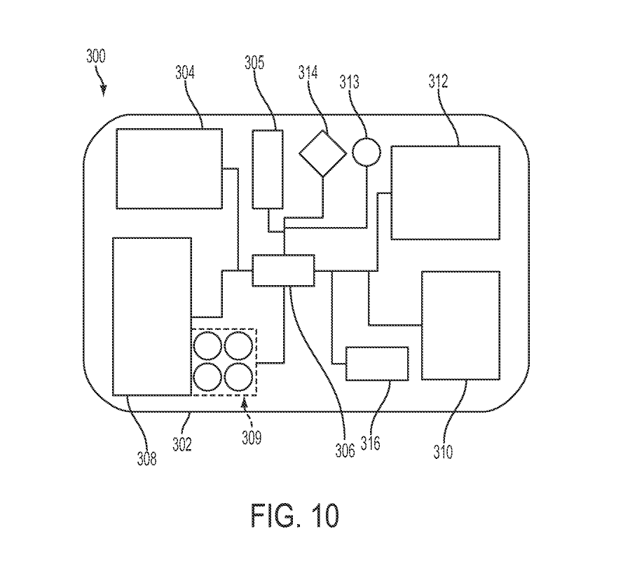

FIG. 10 is a block diagram of an example control unit 300, according to at least some embodiments of the present disclosure. Control unit 300 may include a housing 302, a display 304 (e.g., a touch screen, a liquid crystal display (LCD), light, etc.), a user interface 305 (e.g., a touch screen, button, switch, etc.), a processor 306 (e.g., a computer system, microprocessor, etc., and appropriate associated circuitry), an inflation system 308, inflatable support pressure sensors 309, an ancillary medical device 310, a low air loss air source 312 (e.g., a 50 liter per minute pump/blower), a microphone 313, an alert device 314 (e.g., a buzzer, a speaker, a bell, a light, etc.), and/or a memory 316. In some example embodiments, inflatable support pressure sensors 309 may be disposed in housing 302 and may be fluidicly coupled to respective inflatable support sections 104A, 104B, 104C, 104D. In some example embodiments, inflatable support pressure sensors 309 may be disposed within support structure 100, such as approximate respective inflatable support sections 104A, 104B, 104C, 104D, and may be electrically coupled to processor 306 of control unit 300. Inflatable support pressure sensors 309 may be provided as components of inflation system 308 or separately.

Processor 306 may be operatively connected to display 304, user interface 305, inflation system 308, inflatable support pressure sensors 309, ancillary medical device, low air loss air source 312, microphone 313, alert device 314, memory 316, inflatable mat 201 (e.g., pressure sensor 260), temperature sensor 104T, humidity sensor 104H, angle sensor 102N, and/or other sensors (e.g., an external moisture/incontinence sensor provided in a sheet and/or patient clothing), for example. Control unit 300 and its various components may be powered from an external power source (e.g., a wall plug) and/or may include a battery for temporary or normal use. Some example embodiments may be configured to transmit and/or receive data as discussed in detail below.

Example ancillary medical devices include, without limitation, deep vein thrombosis treatment devices (which may provide intermittent compression of stockings) and negative pressure wound therapy devices (which may apply a vacuum to a dressing placed over a wound).

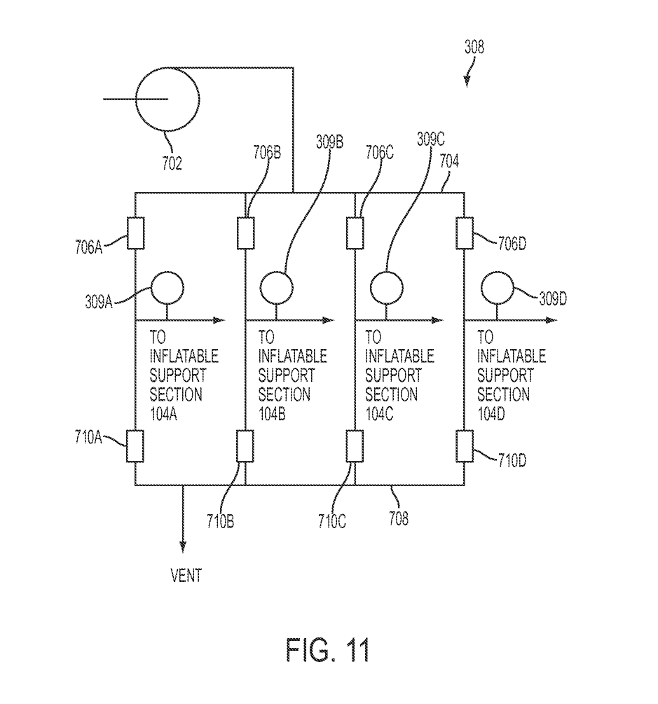

FIG. 11 is a block diagram of an example inflation system 308, according to at least some embodiments of the present disclosure. Some example inflation systems 308 may be configured to be mounted within housing 302 and/or may comprise conduits connectable to inflatable support sections 104A, 104B, 104C, 104D, such as via connectors 114A, 114B, 114C, 114D on external connection panel 114 (FIG. 3). In some example embodiments, a pump 702 (e.g., a 12 VDC pump) may deliver air to a supply manifold 704, which may supply air to a plurality of pump solenoid valves 706A, 706B, 706C, 706D. An individual solenoid valve 706A, 706B, 706C, 706D may be opened or shut (e.g., based on a control signal from processor 306) to deliver air to one inflatable support section 104A, 104B, 104C, 104D, when desired. Similarly, an exhaust manifold 708 may be configured to exhaust air from inflatable support sections 104A, 104B, 104C, 104D when desired via individual exhaust solenoid valves 710A, 710B, 710C, 710D associated with individual inflatable support sections 104A, 104B, 104C, 104D, respectively. Individual inflatable support sections 104A, 104B, 104C, 104D may be fluidicly connected to supply manifold 704 and/or exhaust manifold 708 via tubing or other conduit, which may include pressure sensors 309A, 309B, 309C, 309D. Pump 702, pump solenoid valves 706A, 706B, 706C, 706D, exhaust solenoid valves 710A, 710B, 710C, 710D, and/or pressure sensors 309A, 309B, 309C, 309D may be operatively connected to processor 306.

In some example embodiments, pressure sensors 309A, 309B, 309C, 309D may transmit a voltage signal from 0.5 VDC-1.5 VDC proportional to the air pressure within the respective inflatable support section 104A, 104B, 104C, 104D. This pressure signal may be amplified and sent to a processor which converts the signal to a numerical value between 1 and 1000, for example, for use in control and monitoring operations as descrisupport structure elsewhere herein.

Some example control units 300 may be configured to provide patient weighing functions. For example, processor 306 of control unit 300 may be programmed as patient weighing logic to receive data associated with a pressure of an inflatable mat 201, such as from pressure sensor 260. Processor 306 may be programmed to detect a difference between an unloaded pressure of inflatable mat 201 and a loaded pressure of inflatable mat 201. Processor 306 may be programmed to output a patient weight corresponding to the difference between the unloaded pressure and the loaded pressure. For example, the patient weight may be indicated on display 304.

In accordance with some embodiments of the invention, as discussed in detail below, it may be desired to have a predetermined pressure value pre-programmed into the processor 306 corresponding to a desired pressure. A predetermined pressure in accordance therewith may be a single pressure (in a single zone system) or multiple pressures, corresponding to each zone, in a multiple zone system. One applicable method of determining a model for these pressures in a support structure occupied condition include measuring a large sampling of individuals of multiple weights, manually adjusting the patient support structure 100 to a level wherein support structure sore creation would be limited (i.e. no bottoming out, pressure not too high) for each, recording the individual readings at that time, and creating a corresponding pressure vs. weight model that may be stored within the processor. As would be apparent to one in the art, in the case of a resulting model that is generally linear (or easily susceptible to mathematical simulation), the processor may be programmed with the mathematical formula rather than a database of observed desired pressure for the resulting weight condition. A similar method may be used to determine a model for desired pressures in a support structure unoccupied condition, with the additional step of measuring the observed pressures in an optimally adjusted patient support system condition after the individual used for modeling is no longer on the patient support system. It is considered within the realm of the disclosure to create more finely-tuned models by the use of male vs. female models, younger patient vs. older patient models, large sample size models, etc.

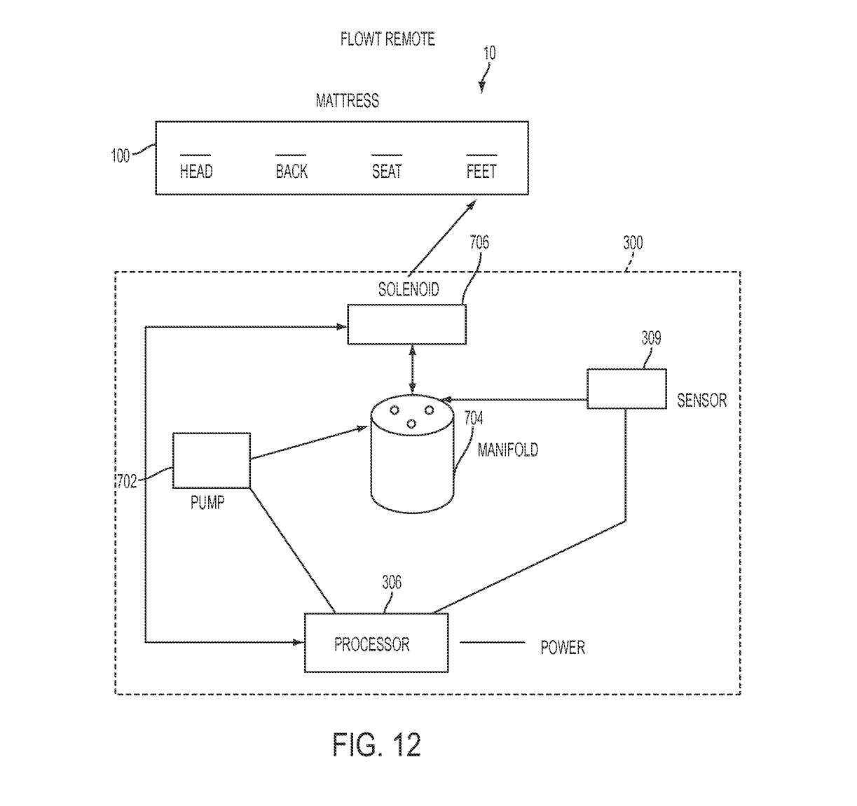

FIG. 12 is a block diagram of an example patient support system 10, according to at least some embodiments of the present disclosure wherein there is only a single zone for inflation of the patient support structure 100. Specifically, a patient support system 10 in accordance with this embodiment, may be comprised of a control unit 300 including a processor 306 that is connected to a pump 702, a pressure sensor 309, and a solenoid valve 706. The pump 702 is fluidly connected to a manifold 704 which is fluidly connected to the solenoid valve 706 which is fluidly connected to the patient support structure 100.

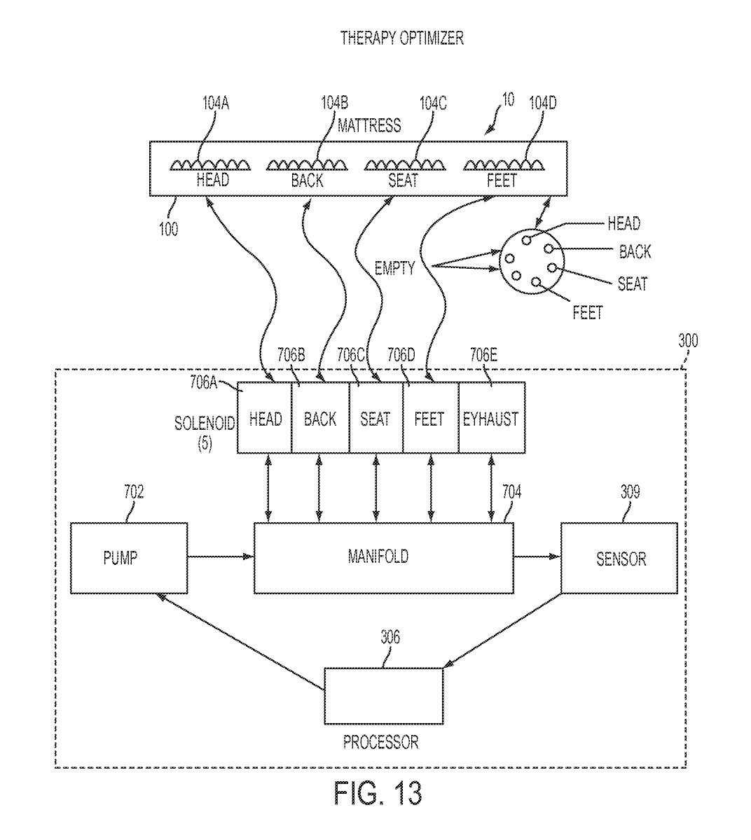

FIG. 13 is a block diagram of an example patient support system 10, according to at least some embodiments of the present disclosure wherein there are multiple zones for inflation of the patient support structure 100. Specifically, a patient support system 10 in accordance with this embodiment, may be comprised of a control unit 300 including a processor 306 that is connected to a pump 702, a pressure sensor 309, and a solenoid valve 706. The pump 702 is fluidly connected to a manifold 704 which is fluidly connected to the solenoid valves 706A, 706B, 706C, 706D, and 706E which are fluidly connected to each respective zone of the patient support structure 100 (104A, 104B, 104C, and 104D, respectively) and the exhaust 104E.

In some example embodiments, inflatable mat 201 may be inflated to a predetermined unloaded pressure (e.g., using a handheld inflator), which may be greater than atmospheric pressure. In some example embodiments, support structure 100 may be placed in a generally horizontal position prior to sensing the loaded pressure. Some example embodiments may display one or more previously obtained patient weights and/or an indication of whether the patient's weight has increased or decreased since the previous weight measurement.

Some example control units 300, such as those incorporating LCDs and/or touch screens, may provide various pages for interacting with users. For example, a “home” page may include one or more button which may be used to switch to mode pages. For example, a home page may include an inflate/deflate button, a support structure exit alarm button, a scale button, a low air loss button, and/or other buttons associated with other functions. Some example mode pages may include a button for returning the screen to the home page. Some example home pages may also display various data, such as angle of the head of the support structure, interface temperature, and/or interface humidity, all of which may be measured as described elsewhere herein.

An example inflate/deflate page may display current pressure readings from individual inflatable support sections 104A, 104B, 104C, 104D. Buttons may direct inflation and/or deflation of individual inflatable supports 104A, 104B, 104C, 104D using inflation system 308. In some example embodiments, processor 306 may be configured to allow user-directed inflation and/or deflation of inflatable supports 104A, 104B, 104C, 104D while preventing deflation of inflatable supports 104A, 104B, 104C, 104D such that the patient exceeds the minimum threshold for bottoming out as detected by proximity sensor mat 202. Some example embodiments may include an animated illustration of the inflation and/or deflation when such operations occur.

An example scale page may include a calibrate button (to be pressed without the patient in the support structure), a current weight button (which may display the weight of the patient), and/or a kg/lb button which may toggle the measurement units. Some example embodiments may also display one or more previously obtained patient weights and/or an indication of whether the patient's weight has increased or decreased since the previous weight measurement.

An example low air loss page may include buttons allowing activation and deactivation of a low air loss air supply and/or adjustment of the low air loss air supply. Some example embodiments may include display of the volumetric flow rate of air provided by the low air loss air supply.

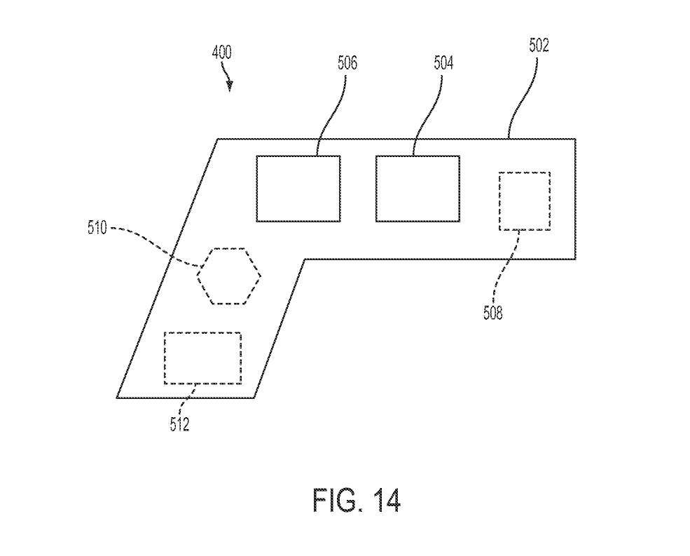

FIG. 14 is a block diagram of an example handheld control unit 400, according to at least some embodiments of the present disclosure. Handheld control unit 400 may comprise control unit 300 (FIG. 1) and/or may be configured to be readily portable. For example, handheld control unit 400 may be carried from support structure to support structure to monitor and/or adjust inflatable supports 104 periodically and/or as desired. For example, handheld control unit 400 may be configured generally in the form of a cordless drill or other readily portable, battery-powered device. In an example embodiment, a housing 502 may receive a display 504 (e.g., an LCD), a user interface 506 (e.g., one or more membrane switches), an inflation system 508 (e.g., a pump and/or a pressure sensor), and/or a processor 510 (which may include memory), all of which may be powered from a battery 512.

Some example handheld control units 400 may be configured to assist a user with setup operations associated with support structure 100. For example, processor 510 may be programmed to ask the user for the patient's height and/or weight. The user may enter the patient's height and/or weight, and processor 510 may determine an appropriate unloaded inflation pressure for individual inflatable support sections 104A, 104B, 104C, 104D. The user may connect inflation system 508 to inflatable support section 104A, handheld control unit 400 may determine the current pressure in inflatable support section 104A, and/or may inflate or vent air as necessary to achieve the desired pressure. This process may be repeated for inflatable support sections 104B, 104C, 104D. In some example embodiments, handheld control unit 400 may ask the user whether the patient is lying on support structure 100 and, if so, handheld control unit 400 may adjust inflatable support sections 104A, 104B, 104C, 104D to appropriate loaded pressures.

Some example embodiments may be configured to store and/or retrieve data associated with a plurality of support structures 100. For example, an example handheld control unit 400 may store data (e.g., desired pressures) for a plurality of support structures designated by support structure numbers or other identifiers. A caregiver may enter the support structure number into handheld control unit 400, and handheld control unit 400 may retrieve the previously stored data associated with that support structure. Some example embodiments may be configured to transmit and/or receive data.

Some example embodiments may be configured to record data for purposes other than billing. For example, certain variations in detected pressures of inflatable supports 104A, 104B, 104C, 104D may be associated with a patient being turned (e.g., from one side to the other side), such as may be performed to reduce the risk of pressure sores. Data related to such turnings may be stored to provide a record that turning procedures were properly carried out by nursing staff. Similarly, temperature, humidity, and other data may be used to show that proper pressure-sore-preventative procedures were conducted. As another example, data associated with the angle of the support structure, pressures of inflatable supports 104A, 104B, 104C, 104D, etc., may be accessed in an investigation related to a patient fall.

In some example embodiments a printed circuit board (PCB) may operatively connect the processor and one or more sensors, solenoid valves, and/or any other data input and/or controlled components. For example a PCB may be connected to the processor using a USB interface. An example PCB may include USB communication modules, one or more potentiometers, one or more amplifiers, and/or appropriate wiring to connect the various components.

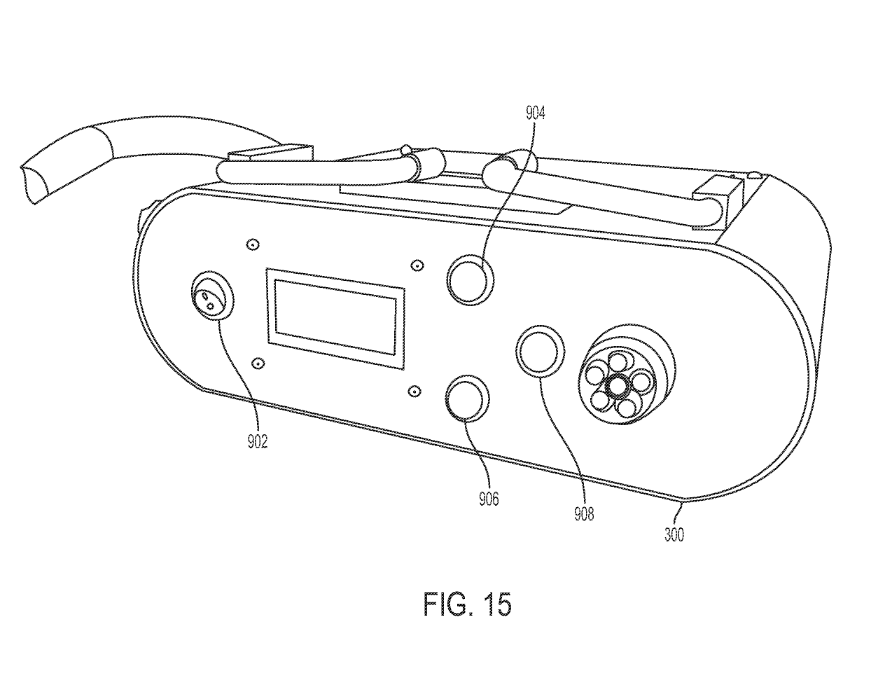

FIG. 15 is a perspective view of an example controller 300 in accordance with at least some aspects of the invention. The controller may include a power switch 900, display 902, scroll up 904, scroll down 906, and enter 908 buttons thereon in accordance with aspects of the disclosure.

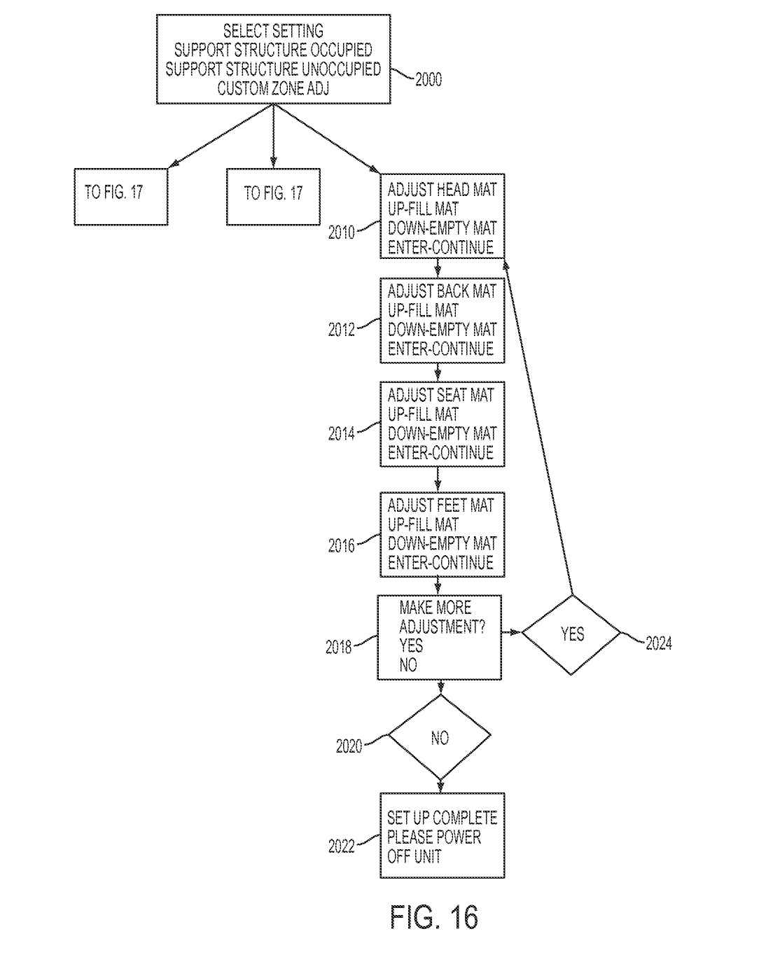

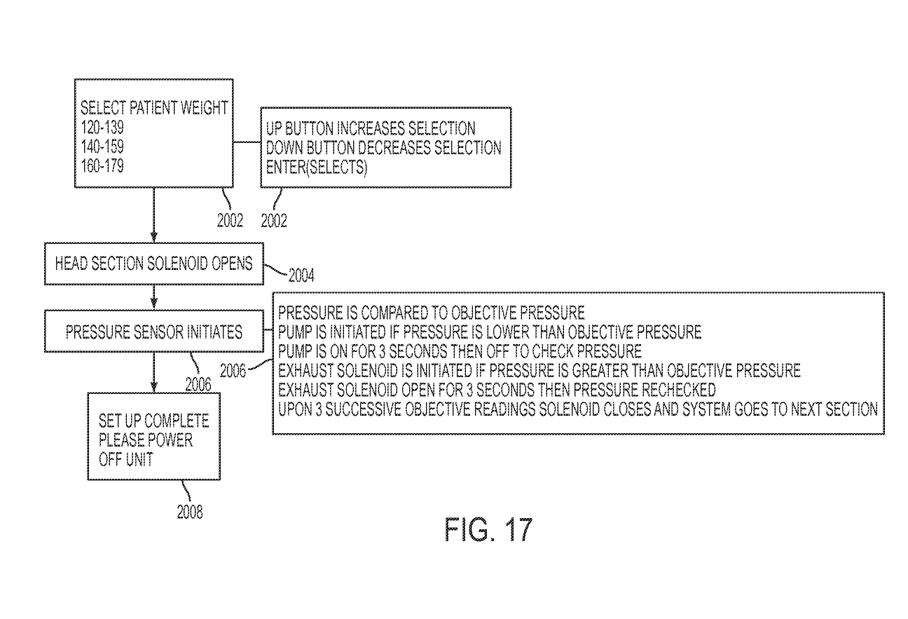

FIGS. 16 and 17 are flowcharts of an example method of operating a patient support system 10 in accordance with some aspects of the present disclosure. Specifically, the method of operating a patient support system in accordance with the disclosure may include the step of a caregiver selecting an option on a controller, such as controller 300 or controller 400, from a support structure occupied, support structure unoccupied, or custom zone adjustment settings menu 2000. If a support structure unoccupied condition is chosen, as shown in FIG. 17, the caregiver may select a patient weight from a list of provided patient weights utilizing up and down buttons 2002 or, alternatively, if the embodiment of the patient support system being utilized incorporates a patient weighing function, the patient weight may simply be read from the weight as calculated automatically by the controller 300 processor.

Next, the head solenoid is opened 2004 thereby allowing airflow from the pump 702 to the support structure 10 initiating the pressure sensor sequence 2006. The pressure sensor sequence 2006 comprises the processor first comparing the pressure read by the sensor to a predetermined pressure corresponding to the desired pressure based upon the model for that pressure as determined for the corresponding weight of the patient. It is noted that in the case of a single zone system, the pressure read and compared to the predetermined pressure at this point is a single pressure. Conversely, in the case of a multiple zone system, the pressures read by the sensors and compared to the predetermined pressures correspond to the number of inflatable zones utilized in the patient support system.

If, at this point, the pressure read is lower than the predetermined pressure, the pump 702 is activated by the processor 306 for a predetermined period of time (for example, 3 seconds). Conversely, if the pressure read is higher than the predetermined pressure, the exhaust solenoid 706E is opened for a predetermined period (for example, 3 seconds). If the pressure read is within a certain predetermined range around the predetermined pressure, nothing is done. This loop is repeated until a predetermined number of pressure sensor 309 readings (such as, for example, 3 times) have been completed with the observed pressure sensor readings being within the predetermined range around the predetermined pressure. At this point, the set-up is now considered complete and the unit is powered off 2008 until next action is needed. Examples of other actions that could occur after this time include periodic system checks that check observed pressure readings at the sensor(s) 309 in the system vs. predetermined pressures and adjustment thereof (if needed) using control loop 2006.

If a support structure unoccupied condition is chosen on the menu by the caregiver, essentially the same method is used as is used in the support structure occupied condition. The 2 distinctions between operation of the system in the support structure occupied vs. the support structure unoccupied condition are: (1) in the support structure unoccupied mode of operation the caregiver must manually select the patient weight 2002 (because the patient is not on the patient support system and thus not capable of being weighed) or the weight must be retrieved from the processor from a previously measured and saved weight for the patient; and (2), the predetermined pressure (or pressures in the case of multiple zone systems) that the processor compares to the observed pressures are lower than the predetermined pressures that the processor compares to the observed pressures in the support structure occupied condition (due to the lack of pressure created by the weight of the patient on the patient support system). Other than these distinctions, the method used, and the sensor control loop 2006, used in the support structure unoccupied condition is the same as that for the support structure occupied condition.

Finally, as shown best in FIG. 16, if the caregiver selects a custom zone adjustment mode of operation, the caregiver is given choices on a menu. Specifically, the caregiver is given the option of adjusting the system (in the case of a single zone system) or the head mat (in a multiple zone system) 2010. The options for the caregiver may include increasing pressure, decreasing pressure, or moving to the next option. In a multiple zone system, additional steps may include adjusting the back mat 2012, the seat mat 2014, and the feet mat 2016 in a corresponding manner. Following adjustments, the caregiver may be provided with an option of making additional adjustments 2018. If the caregiver decides no additional adjustments are needed 2020 the set-up is considered complete and the unit is powered off 2022 until next action is needed. If, however, the caregiver decides yes additional adjustments are needed 2024, the adjustment menu is restarted from the beginning 2010.

In accordance with an aspect of the disclosure, the control unit 300 may include a system check mode. An exemplary embodiment thereof may comprise a program that checks the proper function of major components of the patient support system 10. One exemplary embodiment thereof may comprise a hidden menu that may be accessed as desired. For example, a user could depress and hold an enter button and simultaneously turn on the master power switch. At this time, an audible or visual signal may be sent to the user, such as through a beep, indicating that the system check mode has begun. Aspects of the system check mode in accordance herewith may include a self-diagnostic program that may, for example check the pump, pressure sensor(s), solenoid(s), hose seal(s), etc. and displays error codes if malfunction occurs. Following system check, in accordance herewith, the system may indicate a ready for operation to a user thereof or a system check complete, please power down message.

In accordance with an aspect of the disclosure, the control unit 300 may include a support structure integrity check (for checking to see if there are any leaks in the support structure not readily apparent by a visual inspection). One exemplary embodiment thereof may comprise a hidden menu that may be accessed as desired. For example, a user could depress and hold an UP button on the control unit 300 and turn on master on. At this time, an audible or visual signal may be sent to the user, such as through a beep, indicating that the support structure integrity check has begun. In accordance therewith, the system may begin test by over pressurizing support structure (or individual sections thereof depending on the embodiment). Next, the control unit may direct the valve to release air to a predetermined pressure as sensed by a sensor. Next, after waiting a predetermined period of time (such as, for example, 15 minutes), a follow-up review of the pressures read by the sensor(s) is completed. Comparing the desired pressure to the actual pressure, it is determined whether or not a leak is present in any section(s) of the support structure. In accordance therewith, a listing of section(s) passing or failing may be shown to a user on a display interface of the control unit.

An example method of operating a system check mode on a patient support system 10 in accordance with some aspects of the present disclosure including a system check mode may be provided. Specifically, the method of operating a patient support system in accordance with the disclosure may include the step of a caregiver selecting an option on a controller, such as controller 300 or controller 400, from a support structure occupied, support structure unoccupied, or custom zone adjustment settings menu 2000. If a support structure unoccupied condition is chosen, as shown in FIG. 17, the caregiver may select a patient weight from a list of provided patient weights utilizing up and down buttons 2002 or, alternatively, if the embodiment of the patient support system being utilized incorporates a patient weighing function, the patient weight may simply be read from the weight as calculated automatically by the controller 300 processor.

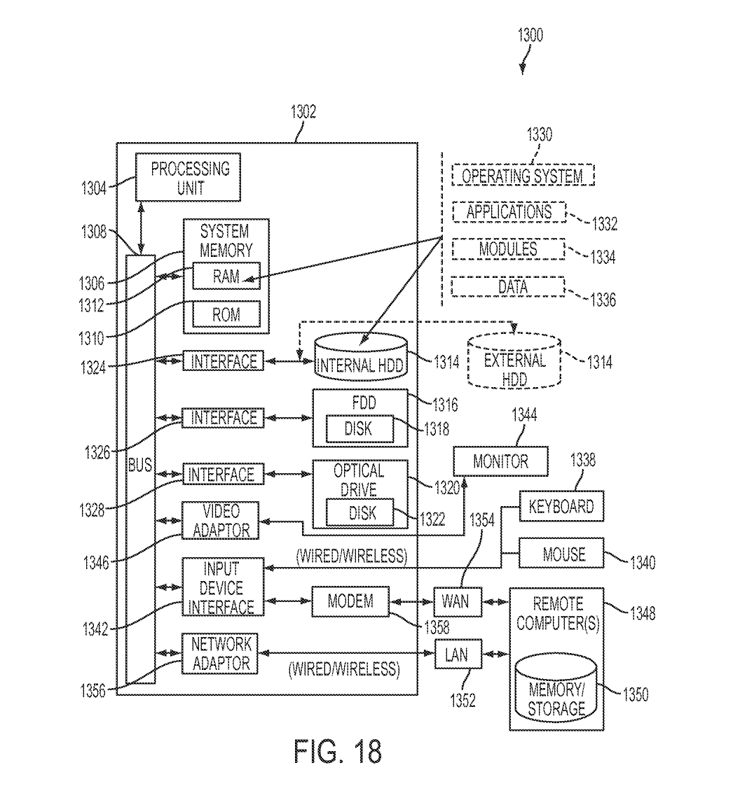

FIG. 18 is a block diagram of an example computer operable with some aspects of the present disclosure. In order to provide additional context for various aspects of the present disclosure, the following discussion provides a brief, general description of a computing environment 1300. Those skilled in the art will recognize that the various aspects of the present disclosure may be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods according to the present disclosure may be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

Some aspects of the present disclosure may also be practiced in distributed computing environments where certain tasks are performed by remote processing devices that are linked through a communications network. In some example distributed computing environments, program modules may be located in local and/or remote memory storage devices.

As shown in FIG. 18, an example computer may include a variety of computer-readable media. Computer-readable media may include any available media that can be accessed by the computer and includes both volatile and non-volatile media, as well as removable and non-removable media. By way of example, and not limitation, computer-readable media may comprise computer storage media and communication media. Computer storage media may include volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

An example computing environment 1300 for implementing various aspects includes a computer 1302, which may include a processing unit 1304, a system memory 1306 and/or a system bus 1308. The system bus 1308 may couple system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structures that may further interconnect to a memory bus (with or without a memory controller), a peripheral bus, and/or a local bus using any of a variety of commercially available bus architectures. The system memory 1306 may include read only memory (ROM) 1310 and/or random access memory (RAM) 1312. A basic input/output system (BIOS) may be stored in a non-volatile memory 1310 such as ROM, EPROM, EEPROM. BIOS may contain basic routines that help to transfer information between elements within the computer 1302, such as during start-up. The RAM 1312 can also include a high-speed RAM such as static RAM for caching data.

The computer 1302 may further include an internal hard disk drive (HDD) 1314 (e.g., EIDE, S ATA), which may also be configured for external use in a suitable chassis, a magnetic floppy disk drive (FDD) 1316 (e.g., to read from or write to a removable diskette 1318), and/or an optical disk drive 1320 (e.g., reading a CD-ROM disk 1322 or, to read from or write to other high capacity optical media such as the DVD). The hard disk drive 1314, magnetic disk drive 1316, and/or optical disk drive 1320 can be connected to the system bus 1308 by a hard disk drive interface 1324, a magnetic disk drive interface 1326, and an optical drive interface 1328, respectively. The interface 1324 for external drive implementations may include at least one or both of Universal Serial Bus (USB) and IEEE 1394 interface technologies. Other external drive connection technologies are within the scope of the disclosure.

The drives and their associated computer-readable media may provide nonvolatile storage of data, data structures, computer-executable instructions, and so forth. For the computer 1302, the drives and media may accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in an example operating environment, and further, that any such media may contain computer-executable instructions.

A number of program modules can be stored in the drives and RAM 1312, including an operating system 1330, one or more application programs 1332, other program modules 1334, and/or program data 1336. All or portions of the operating system, applications, modules, and/or data can also be cached in the RAM 1312. It is to be appreciated that various commercially available operating systems or combinations of operating systems may be utilized.

A user can enter commands and information into the computer 1302 through one or more wired/wireless input devices, e.g., a keyboard 1338 and a pointing device, such as a mouse 1340. Other input devices may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device may also connected to the system bus 1308 via an interface, such as a video adapter 1346. In addition to the monitor 1344, a computer typically includes other peripheral output devices, such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor based entertainment appliance, a peer device, and/or other common network node, and/or may include many or all of the elements descrisupport structure relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and health care facilities, and facilitate enterprise-wide computer networks, such as intranets, all of which may connect to a global communications network, e.g., the Internet.

When used in a LAN networking environment, the computer 1302 may be connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or may be connected to a communications server on the WAN 1354, or may have other devices for establishing communications over the WAN 1354, such as by way of the Internet. The modem 1358, which can be internal or external and a wired or wireless device, may be connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag, and/or telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a support structure in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.1a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can operate in more than one band (e.g., dual band), so the networks can provide real-world performance similar to the basic 10BaseT wired Ethernet networks used in many offices.

All dimensions provided herein are merely examples and are not to be considered limiting.

While example embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages may exist even though they may not have been explicitly discussed herein.

1. A patient support system comprising:
a planar patient support structure having at least one chamber therein for receiving and maintaining a fluid and for receiving a patient thereon, said patient having a weight;
a pump fluidicly connected to said support structure;
at least one pressure sensor for sensing a fluid pressure in said chamber; and
a processor-based control unit operatively connected to said pressure sensor to receive a pressure sensor signal and operatively connected to said pump to control said pump, and further adapted to at least one of receive and calculate a signal representative of said patient weight;
said control unit being configured to operate said pump to achieve a predetermined pressure in said chamber based at least upon said patient weight signal and said pressure sensor signal; and
said predetermined pressure being determined by said control unit according, at least in part, to an electronically stored pressure versus weight model accessible to said control unit, said pressure versus weight model being set to avoid bottom-out and overpressure conditions for said patient having said weight.

2. The patient support system of claim 1 wherein the patient support system is a bed.

3. The patient support system of claim 1 wherein the patient support system is a wheelchair pad.

4. The patient support system of claim 1 wherein the patient support system is a gurney pad.

5. The patient support system of claim 1 wherein the patient support system is an OR pad.

6. The patient support system of claim 1 wherein, said control unit is further configured, prior to said control unit operating said pump to achieve a predetermined pressure, to perform a system check to check the proper function of at least the pressure sensor and pump.

7. The patient support system of claim 1 wherein, said control unit is further configured, prior to said control unit operating said pump to achieve a predetermined pressure, to perform a support structure integrity check that includes operating said pump to apply pre-check pressure to said support structure and thereafter comparing pressure signals over a period of time to determine if a leak is present in said support structure.

8. The patient support system of claim 1 wherein said control unit is configured to achieve said predetermined pressure the patient is on the support structure.

9. The patient support system of claim 8, wherein said control unit is configured to calculate said signal representative of said patient weight based at least upon a comparison of a patient-on pressure sensed by said pressure sensor versus a patient-off pressure sensed by said pressure sensor.

10. The patient support system of claim 1 wherein said control unit is configured to achieve said predetermined pressure the patient is not on the support structure.

11. The patient support system of claim 1 wherein said control unit is configured to receive said signal representative of said patient weight as manual input by a user.

12. The patient support system of claim 1 wherein said control unit is configured to receive said signal representative of said patient weight as an electronic transmission from a weight sensor.

13. The patient support system of claim 12 wherein said electronic transmission is via WiFi.

14. The patient support system of claim 1 wherein:
said patient support structure includes a plurality of support sections, each of which includes a support section chamber that is separately inflatable;
said pump is fluidicly connected to said each of said support section chambers via at least one of a manifold and tubing;
said pump includes a plurality of valves respectively provided in fluid communication between said pump and said plurality of support section chambers;
said patient support structure includes a plurality of pressure sensors respectively sensing a fluid pressure in each of said support section chambers, each pressure sensor providing a pressure sensor signal to said control unit;
said control unit is configured to operate said pump and said plurality of valves to achieve a plurality of predetermined pressures in each of said support section chambers based at least upon said patient weight signal, said plurality of pressure sensor signals and said pressure versus weight model.

15. A method of operating a patient support system comprising:
obtaining a weight of a patient;
opening at least one valve by a processor-based control unit, said valve opening establishing a fluidic connection between a pump and at least one chamber of an inflatable patient support structure; and
automatically adjusting, by said processor-based control unit, a real fluid pressure within said chamber according to an electronically stored pressure versus weight model accessible to said control unit until said real fluid pressure substantially reaches an objective fluid pressure, wherein said objective fluid pressure avoids bottom-out and overpressure conditions for said patient having said weight.

16. The method of claim 15, wherein the obtaining step comprises obtaining by said processor-based control unit said weight that has been manually entered by a user.

17. The method of claim 15, wherein the obtaining step comprises calculating, by said processor-based control unit, said weight of said patient, said calculation being based upon a difference of a sensed pressure in said at least one chamber after said patient is placed onto said patient support structure and a sensed pressure in said at least one chamber before said patient is placed onto said patient support system.

18. The method of claim 15, wherein the automatic adjusting step comprises:
initiating, by said processor-based control unit, an automatic pressure sensor sequence, said pressure sensor sequence comprising,
sensing, by a pressure sensor operatively connected to said chamber and to said processor-based control unit, said real fluid pressure in said chamber,
comparing said real fluid pressure to said objective fluid pressure, and
altering, by operating said pump and an exhaust valve, said real fluid pressure of said chamber until said real fluid pressure substantially reaches said objective fluid pressure.

19. The method of claim 18, wherein said processor-based control unit loops said automatic pressure sensor sequence until said pressure sensor senses said real fluid pressure to be substantially equal to said objective fluid pressure a pre-defined consecutive number of times.
